(19) United States
(12) Patent Application Publication
(10) Pub. No.: US 2008/0107263 A1
(43) Pub. Date: May 8, 2008

(54) System, method & apparatus for display screen security

(76) Inventor: Michael Bastanchury, Santa Barbara, CA (US)

Correspondence Address: LAW OFFICES OF ANDREW Y. SCHROEDER, 500 SOUTH BROADWAY, SUITE 222, SANTA MARIA, CA, 93454, US

(21) Appl. No.: 11/592,400

(22) Filed: Nov. 2, 2006

(51) Int. Cl. H04N 7/167

(52) U.S. Cl. 380/201

(57) ABSTRACT

A system for preventing others from discerning visual imagery, data, entertainment or other informative indicia transmitted through pixels from a display screen from which encrypting light and indicia light is transmitted comprising a computer program, a lens, and encrypting light.

### FIELD OF THE INVENTION

The present invention relates with display screens and computer technology, and more specifically relates with a system, method, and apparatus for safeguarding data, visual imagery, entertainment, and other indicia upon computer screens of unattended computers or other display screens by others.

### BACKGROUND OF THE INVENTION

Accompanying the proliferation of laptop computers found in cafes, desktop computers in narrow cubicles, and the increased importance of trade secrets and intellectual property is an increasing need to safeguard information displayed on computer screens. Today, information displayed upon computer screens may contain secret chemical formulas, attorney-client privileged letters, client lists and phone numbers. If this information is stolen the value lost and the damage entailed thereby can become far more devastating than the loss of a wallet or an expensive article of jewelry. The loss of this sensitive information may result in the loss of a job, identity theft, a loss of business, and years of work. Unfortunately, most security procedures are not very effective or feasible.

For instance, if a business executive flying across country would like to transcribe his thoughts and recollections regarding his recently completed meeting onto his laptop computer he may be seated between two strangers within close proximity. In this event the business executive would have two choices: either wait until after the flight and after he arrives home, or just hope the two strangers will avert their eyes. The first choice may be completely unacceptable if the business executive needs to quickly memorialize his recent meeting before he begins to forget some of the more intricate details. If this business executive must wait until after he arrives home or even the next morning he may forget a substantial amount of the substance of the recently completed meeting. Alternatively, the second choice may expose him and his employers to substantial consequences in the event the two strangers seated aside from him choose to misappropriate his notes.

Another increasingly encountered problem is the theft of sensitive files and programs through flash drives and similar devices. The prevalence of flash drives makes it easy for a predator to quickly steal a file and abscond with the files without a trace. Most flash drives today are so small they may fit onto someone's keychain. In addition, they may be quickly plugged into a USB port to steal a file, and they may be quickly removed without much effort. In the past, if one attempted to steal files directly off a computer, a CD would have to be used which would take up to a couple minutes. A flash drive can enable a file theft in a matter of seconds.

Yet another problem frequently encountered is identity theft. In today's marketplace more transactions are consummated over the Internet. These transactions typically require sensitive information such as credit card numbers, social security numbers, passwords and other identifying information. This creates an opportunity for predators who frequently come into close quarters with those who frequently use laptop computers to make their purchases.

Unfortunately, the marketplace has not adequately addressed these issues. One common apparatus used to conceal data on computer screens are filters which are affixed to the computer screen. This filter works to obscure the display screen from various angles such that a neighbor seated beside may not be able to completely view the contents of the display screen. However, the filter apparatus cannot obscure the view of an unintended observer standing substantially perpendicularly with the computer screen. Moreover, the filter apparatus will not prevent a predator from quickly plugging a flash drive into the USB port and quickly stealing the files while the owner is away.

Therefore, what is clearly needed in the art is a system and apparatus which can completely obscure a computer screen to unintended viewers, yet enable the intended viewer to completely view the contents of the computer screen.

### SUMMARY OF THE INVENTION

It is an object of the present invention to provide a unique system, apparatus, and method in order to prevent others from discerning visual imagery, data, entertainment or other informative indicia upon a display screen. This system will be optionally able to run continuously from the time the display screen is activated to the time it is deactivated in order to prevent another person from viewing the contents by theft or other misappropriation. Or, in some embodiments the present invention may run only when specific files, programs, or applications are activated in conjunction with the display screen.

The present invention incorporates use of a lens, a program, and encrypting light. In some preferred embodiments the lens may be incorporated into a pair of glasses to be worn by the intended user. These glasses would be enabled to decode the encrypted images either by polarization means or by correcting the angular offset from the display screen. In the former embodiment, the glasses would be polarized in order to filter out the predetermined encrypting wavelengths of light. In the latter embodiment, the glasses would be similar to or may incorporate “3-D” or three dimensional glasses which correct the angular offset images produced by the display screen. These three dimensional glasses may be suitably polarized as well in order to correct the angular offset.

The program enables the system to generate the encrypted images either by using predetermined wavelengths of light which are used to eclipse, manipulate, obscure, distort, or otherwise render unintelligible the indicia light. In some preferred embodiments the program interposes encrypting pixels between the indicia pixels. After the encrypting pixels are interposed between the indicia pixels, the program directs the display screen to transmit light from the encrypting pixels. Optionally, the program may further calibrate the color presets or configurations of the display screen in order to ensure that the precise wavelength of light is transmitted.

The encrypting light transmitted from the encrypting pixels in some preferred embodiments may comprise a wavelength of light selected from the visible light spectrum between 620-750 nanometers. In other preferred embodiments the encrypting light may be modified to produce an angular offset thereby rendering the screen or some of the contents unintelligible.

### BRIEF DESCRIPTION OF THE DRAWING FIGURES

FIG. 1 is a plan view of a preferred embodiment of the present invention.

FIG. 2 is a perspective view of a preferred embodiment of the present invention.

FIG. 3 is a perspective view of a preferred embodiment of the present invention.

FIG. 4 is a flow diagram view of a preferred embodiment of the present invention.

FIG. 5 is a plan view of a preferred embodiment of the present invention.

FIG. 6 is a flow diagram view of a preferred embodiment of the present invention.

### DESCRIPTION OF PREFERRED EMBODIMENTS

According to a preferred embodiment of the present invention, a unique system, apparatus, and method is used to prevent others from discerning visual imagery, data, entertainment or other informative indicia (those intended images or information to be encrypted shall hereafter be referred to as indicia 110) upon a display screen. The present invention is described in enabling detail below.

For the purposes of the present invention the term “encrypt” means the process of obscuring or otherwise rendering an intended message or visual imagery or other intended display unintelligible in order to preserve the intended indicia to be illustrated upon the display screen. The term “encrypt” may further incorporate the function of modifying, altering, or otherwise eclipsing/obscuring the intended messages, indicia, or other intended visual imagery. The term “encrypt” may further include the function of intentionally conveying a false message, image, etc. for the purpose of misinforming an unintended observer about the true nature of the information or images.

For the purposes of the present invention the term “display screen” may mean any television set, computer screen, high definition television (HDTV), cathode ray tube (CRT), EDTV, digital enabled display screens, analog display screens, monitors, personal digital assistant screens or other screens used for the purpose of displaying indicia or other visual imagery upon a screen. The present invention is not limited for use solely for computer systems. In some preferred embodiments the display screen and accompanying system may possibly be a stand-alone system. The present invention shall be construed as further incorporating other display screens not in communication with a computer.

For the purposes of the present invention the term “encrypting pixels” shall mean those pixels which comprise a display screen which will transmit light which is used to obscure, eclipse, alter, modify, distort or otherwise render unintelligible the light which is transmitted for the purpose of illustrating the intended indicia, data, visual imagery, entertainment, or other intended light.

For the purposes of the present invention the term “indicia pixels” shall mean those pixels which comprise a display screen which will transmit light which is used to illustrate an intended message, data, indicia, entertainment, visual imagery, etc. upon the display screen.

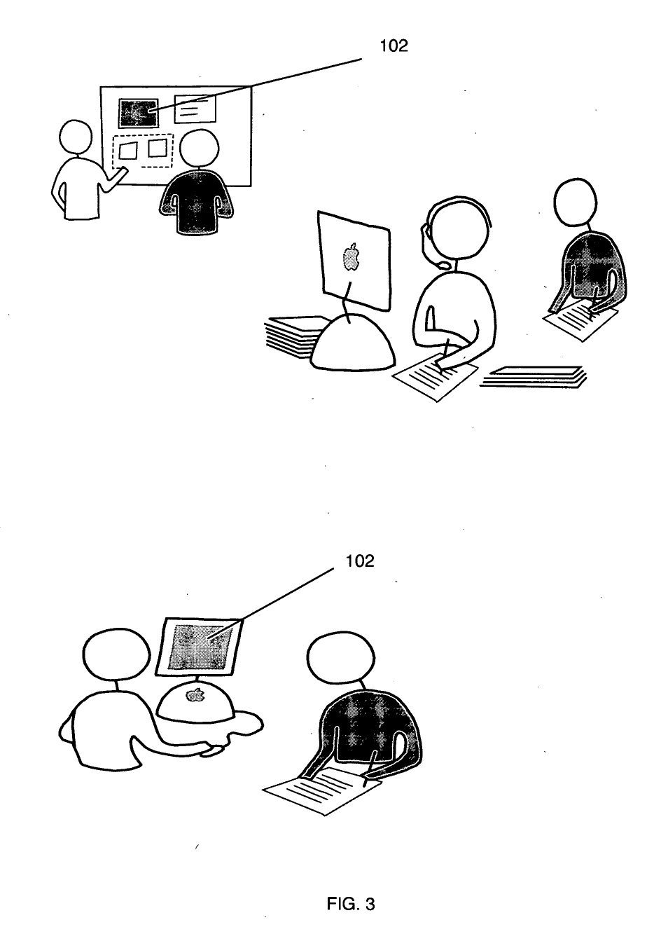

For the purposes of the present invention the term “others” or “unintended viewers or observers” shall mean those third parties or anyone other than the intended viewer for which the present invention is designed to hide, obscure, manipulate, or otherwise render the contents to be displayed by the display screen to be unintelligible. FIG. 3 illustrates typical (these are illustrative examples only and do not limit the scope or application of the present invention) situations where the present invention may be expedient for the purpose of encrypting the contents of a display screen.

It should be noted here that the encrypting pixels and indicia pixels of a display screen refer to a specific instant of time. Any of the pixels of a display screen can become either an indicia pixel or an indicia pixel at any given time.

For the purposes of the present invention the term “wavelength” refers to a portion of the spectrum of light which is often referred to in nanometers. Although there may not necessarily be a clear boundary between the color red and the color blue, the use of the term “wavelength” shall refer to a portion of the spectrum of light.

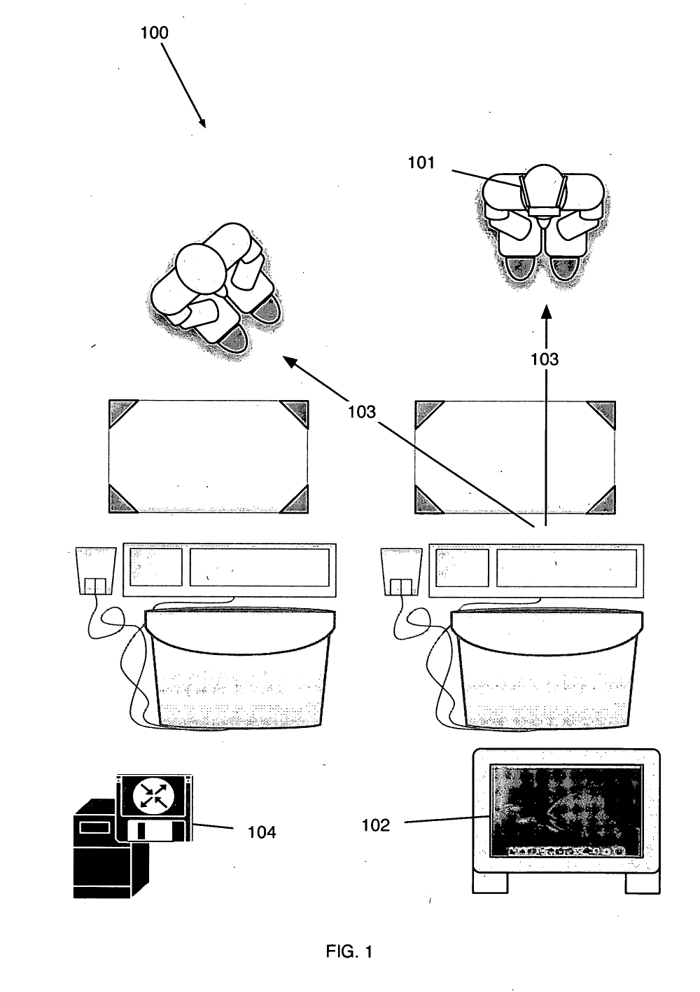

FIG. 1 illustrates a preferred embodiment of the present invention. Display screen security system (hereafter DSSS) 100 comprises a system for preventing others from discerning visual imagery, data, entertainment or other informative indicia transmitted by indicia light upon a display screen comprised of pixels. The system comprises a lens 101, encrypting light 103 generated from the display screen 102, and a program 104 with instructions for encryption. For the purposes of the present invention, the term “indicia light” shall mean that light transmitted by the display screen which generates the intended visual imagery, indicia, data, entertainment, or other informative indicia. Whereas, the encrypting light 103 shall refer to that light transmitted by the display screen for the purpose of obscuring, eclipsing, overshadowing, overpowering, or otherwise rendering the indicia light unintelligible or incapable of conveying the intended indicia, visual imagery, or other data.

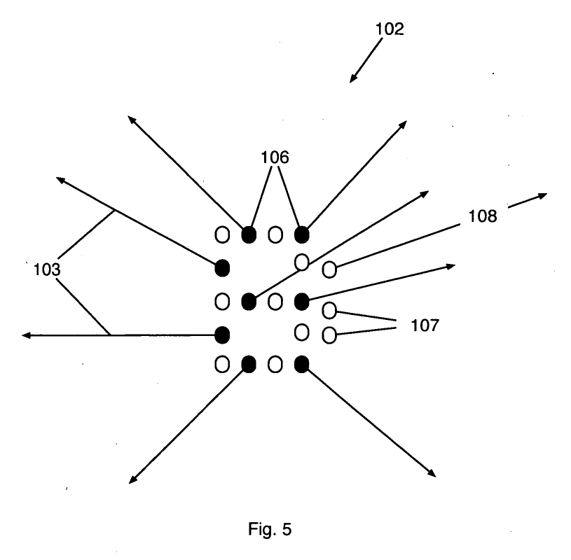

FIG. 5 illustrates a portion of a display screen 102 which is comprised of encrypting pixels 106 which emit encrypting light 103 and indicia pixels 107 which emit indicia light 108.

The computer program 104 is stored on a computer readable medium and executable by a computer system. The computer program includes instructions for transmitting encrypting light 103 from the display screen 102 comprised of pixels. Encrypting light 103 is transmitted from the display screen for the purpose of obscuring, eclipsing, or preventing an unintended observer from discerning the intended visual imagery, data, entertainment, or other informative indicia upon the display screen. The intended visual imagery, data, entertainment, or other informative indicia is transmitted from the indicia pixels. The encrypting pixels transmits the encrypting light.

It should be noted here that in some preferred embodiments the program may be optionally enabled to run continuously from the time the display screen is activated to the time it is deactivated in order to prevent another person from viewing the contents by theft or other misappropriation. Or, in other preferred embodiments the present invention may run only when specific files, programs, or applications are activated in conjunction with the display screen. There are many different possibilities for possible ways in which the system 100 may operate pursuant to the objective of protecting or encrypting various information, imagery, entertainment, files, information, etc. For this reason, the present invention should not be construed to only work with one particular application, program, or file. In point of fact, the present invention may possibly be integrated into an operating system such that everything illustrated from the display screen would be encrypted.

The present invention also incorporates at least one lens 101. The lens is incorporated for the purpose of discerning the intended visual imagery, data, entertainment, or other informative indicia upon the display screen transmitted to an intended viewer's eye(s) which has been encrypted by the encrypting light.

In some preferred embodiments, the encrypting light 103 is composed of a predetermined wavelength of light for the purpose of obscuring, eclipsing, or otherwise encrypting the indicia light transmitted by the display screen. Furthermore, in some preferred embodiments, the encrypting light 103 may be characterized as being reddish. The reason why the reddish wavelengths may be used is that they tend to obscure, eclipse, overpower, or otherwise distort other wavelengths of light. This part of the visible spectrum consists of wavelengths between 620 nanometers to 750 nanometers. Although it is preferred to use this spectrum other parts of the spectrum of light may also be used in the present invention for the purpose of generating and transmitting encrypting light from the display screen.

It should also be noted that in some preferred embodiments there may be either one or a plurality of wavelengths of encrypting light. For instance, two or more sets of encrypting pixels may emit a plurality of predetermined wavelengths of light between 620-750 nanometers. In this case the polarized glasses may comprise one lens which is polarized for one particular predetermined wavelength of encrypting light, and the other lens may be specifically polarized to filter the other predetermined encrypting wavelength of light. For this reason, there may be a plurality of sets of predetermined wavelengths of light used with the present invention. Consequently, there may be a plurality of polarized lenses correspondingly accompanying the encrypting sets of predetermined wavelengths of light. The possibilities are endless as to the possible permutations.

In other preferred embodiments the encrypting light 103 is composed of light which distorts the angular transmission of light for the purpose of obscuring, eclipsing, or otherwise distorting the indicia light transmitted by the display screen in such a way as to render the resulting images unintelligible, or incapable of conveying the intended indicia, visual imagery, or other data. This resulting angular offset can also encrypt the indicia light. One example of this angular distortion may be “3D” or three dimensional effects.

The lens 101 enables the intended viewer to discern visual imagery, data, entertainment or other informative indicia upon a display screen by filtering out the predetermined wavelengths of encrypting light transmitted from the display screen comprised of pixels. In some preferred embodiments the lens may be polarized in order to enable an intended observer to discern the visual imagery, data, entertainment or other informative indicia upon a display screen.

For instance, if the computer program were to instruct the encrypting pixels to transmit a reddish wavelength of 700 nanometers, the lens 101 would be correspondingly polarized in order to filter the wavelength of 700 nanometers thereby enabling an intended observer to discern the intended data, indicia, or visual imagery transmitted by the indicia pixels.

It should be noted here that there are an infinite number of strata of the reddish spectrum of light which can produce an infinite number of possible combinations of encrypting light. That is to say, the present invention can be theoretically sold to an infinite number of end users such that each end user will have a unique encrypting light and mating decoding lens such that other end users will not be able to discern each other's display screens with their respective lenses or glasses.

In some preferred embodiments the lens 101 enables the intended viewer to discern visual imagery, data, entertainment or other informative indicia upon a display screen by correcting the angular offset created by the encrypting light. One example would be to generate three dimensional images which would only be discerned through use of a correspondingly polarized lens.

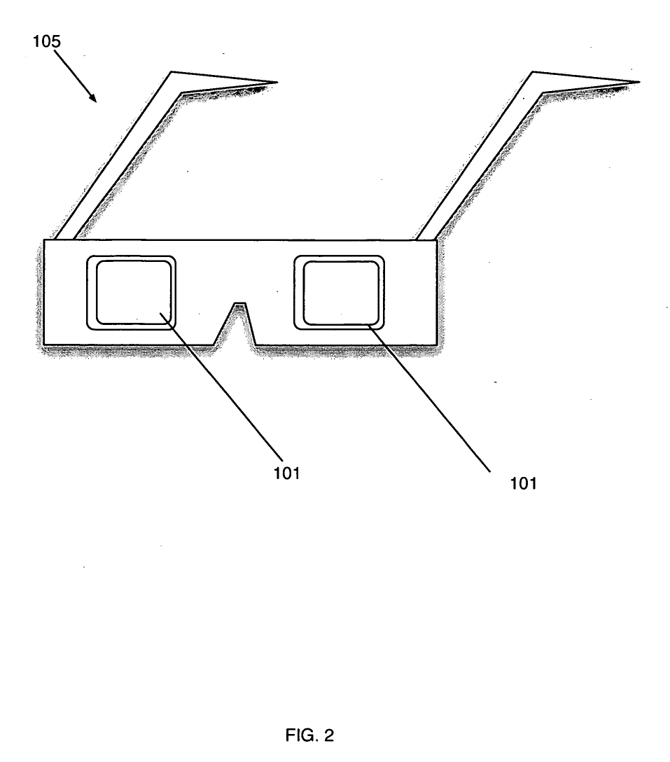

FIG. 2 illustrates that in some preferred embodiments the system might further comprise a frame 105 for use in retaining the two lenses 101. The frame and the two lenses will consequently form a pair of wearable glasses for the intended observer.

In those preferred embodiments which incorporate the technique of angular distortion or offsets, “3D” three dimensional glasses will be used to enable an end user to discern the visual imagery, data, or other intended indicia illustrated upon the display screen.

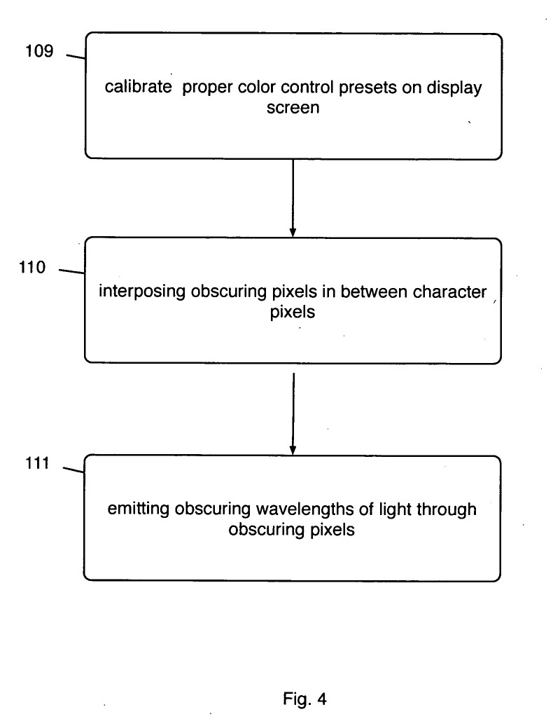

FIG. 4 illustrates a preferred method to be used in the present invention. The program comprises the following steps: (a) Interposing 110 encrypting pixels in between indicia pixels and (b) Emitting 111 encrypting light through encrypting pixels.

The system may further comprise a step of calibrating 109 the color configurations or presets of the display screen. By calibrating the color controls or presets of the display screen, the system can ensure that the display screen will emit a correct wavelength of light which is correspondingly filtered by the mating lens intended to be furnished with the program.

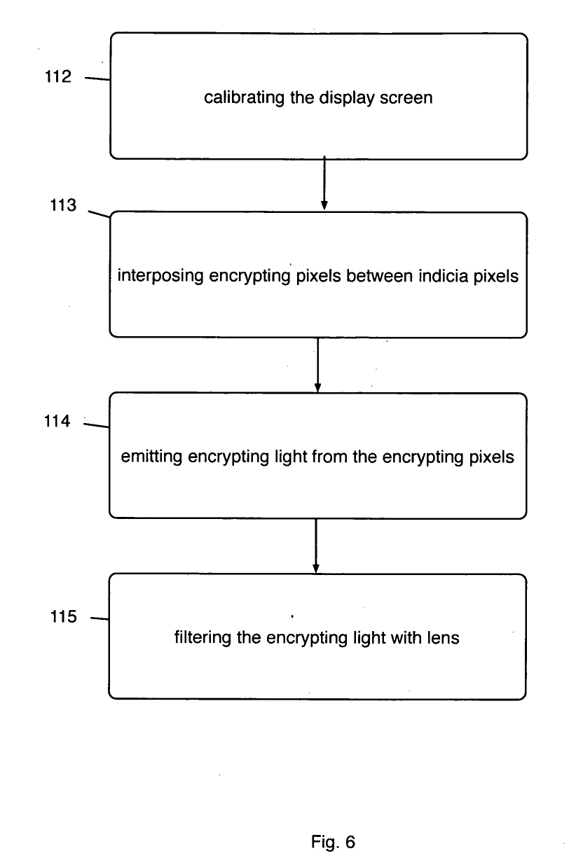

FIG. 6 illustrates a preferred method to be used with the present invention. In step one 112, the system calibrates the display screen in order to emit the correct wavelengths of light. In step two, 113 the system interposes encrypting pixels between indicia pixels. In step three 114, the system transmits light from the encrypting pixels. And in step four 115 the encrypting light is filtered with the lens in order to discern the intended data, imagery, information, etc

The preferred method to be used with the present invention is used in conjunction with a system which comprises a computer program, stored on a computer readable medium and executable by a computer system. The computer program comprises instructions for transmitting encrypting light from the display screen comprised of pixels. Also incorporated in the system is encrypting light transmitted to an intended viewer's eye(s) for the purpose of obscuring, eclipsing, or preventing an unintended observer from discerning the intended visual imagery, data, entertainment, or other informative indicia upon the display screen

The system further incorporates at least one lens for the purpose of discerning the intended visual imagery, data, entertainment, or other informative indicia upon the display screen transmitted to an intended observer's eye(s) which has been encrypted by the encrypting light transmitted to an intended viewer's eye(s).

It will be apparent to the skilled artisan that there are numerous changes that may be made in embodiments described herein without departing from the spirit and scope of the invention. For example, it should be noted here that the present invention may be enabled to encrypt the display screen by re-configuring other properties of light through other optics-related methods. For this reason, the present invention should be broadly construed to further include other means of encryption.

As such, the invention taught herein by specific examples is limited only by the scope of the claims that follow.

What is claimed is:

1. A system for preventing others from discerning visual imagery, data, entertainment or other informative indicia transmitted through pixels from a display screen from which encrypting light and indicia light is transmitted comprising:
a computer program, stored on a computer readable medium and executable by a computer system, the computer program comprising instructions for transmitting encrypting light from the display screen,
encrypting light for the purpose of obscuring, eclipsing, or preventing others from discerning the intended visual imagery, data, entertainment, or other informative indicia illustrated upon the display screen, the encrypting light is transmitted from a plurality of encrypting pixels of the display screen,
at least one lens to be used by an intended viewer for the purpose of discerning the intended visual imagery, data, entertainment, or other informative indicia upon the display screen transmitted by the display screen which has been encrypted by the encrypting light.

2. The system of claim 1 wherein the encrypting light is composed of a predetermined wavelength of light for the purpose of obscuring, eclipsing, or otherwise encrypting the indicia light transmitted by the display screen.

3. The system of claim 1 wherein the encrypting light is composed of light which distorts the angular transmission of light for the purpose of obscuring, eclipsing, manipulating or otherwise distorting the indicia light transmitted by the display screen.

4. The system of claim 1 wherein the lens enables the intended viewer to discern visual imagery, data, entertainment or other informative indicia upon a display screen by filtering out the predetermined wavelengths of encrypting light transmitted from the display screen comprised of pixels.

5. The system of claim 2 wherein the lens is polarized in order to enable an intended observer to discern the visual imagery, data, entertainment or other informative indicia upon a display screen.

6. The system of claim 3 wherein the lens is polarized in order to enable a person to discern the visual imagery, data, entertainment or other informative indicia upon a display screen.

7. The system of claim 1 wherein the lens enables the intended viewer to discern visual imagery, data, entertainment or other informative indicia upon a display screen by correcting the angular offset created by the encrypting light.

8. The system of claim 3 further comprising a pair of three dimensional glasses for the purpose of correcting the angular offset transmitted by the display screen for the purpose of encrypting the indicia light from the display screen.

9. The system of claim 2 wherein the system is comprised of at least 2 lenses.

10. The system of claim 1 wherein the encrypting light consists of a predetermined wavelength of light selected from a spectrum of wavelengths between 620 nanometers to 750 nanometers.

11. The system of claim 9 further comprising a frame for use in retaining the 2 lenses, the frame and the 2 lenses forming a pair of wearable glasses for the intended observer for the purpose of discerning visual imagery, data, entertainment or other informative indicia upon a display screen comprised of pixels.

12. The system of claim 3 wherein the program comprises the following steps:
a. Interposing encrypting pixels in between indicia pixels and
b. Emitting encrypting light through encrypting pixels.

13. The system of claim 12 further comprising the step of calibrating the color configurations of the display screen.

14. The system of claim 13 wherein the encrypting light is comprised of a wavelength of light between 620 nanometers and 750 nanometers the wavelength of light to correspond with the lens which is specifically polarized to filter out the encrypting light.

15. The system of claim 1 wherein the display screen is a high definition monitor.

16. A method of preventing others from discerning visual imagery, data, entertainment or other informative indicia transmitted by indicia light upon a display screen comprised of pixels through use of encrypting light comprising the steps:
a. interposing encrypting pixels between indicia pixels;
b. transmitting encrypting light from encrypting pixels;
c. decoding the light transmitted from the display screen through use of a lens.

17. The method of claim 16 further comprising the step of calibrating the color controls of the display screen.

18. The method of claim 16 wherein a system comprises
a computer program, stored on a computer readable medium and executable by a computer system, the computer program comprising instructions for transmitting encrypting light from the display screen comprised of pixels,
encrypting light transmitted by the display screen for the purpose of obscuring, eclipsing, or preventing others from discerning the intended visual imagery, data, entertainment, or other informative indicia upon the display screen,
at least one lens for the purpose of discerning the intended visual imagery, data, entertainment, or other informative indicia upon the display screen transmitted to an intended observer's eye(s) which has been encrypted by the encrypting light transmitted by the display screen.

19. The method of claim 18 wherein the encrypting light consists of predetermined wavelength of light between 620 nanometers and 750 nanometers.

20. A system for preventing others from discerning visual imagery, data, entertainment or other informative indicia transmitted by indicia light upon a display screen comprised of pixels comprising:
a computer program, stored on a computer readable medium and executable by a computer system, the computer program comprising instructions for transmitting encrypting light from the display screen comprised of pixels, the instructions comprising: interposing encrypting pixels between indicia pixels and transmitting encrypting light and indicia light from the display screen;
a pair of polarized glasses to be used by an intended viewer for the purpose of discerning the intended visual imagery, data, entertainment, or other informative indicia upon the display screen transmitted to an intended observer's eye(s) which has been encrypted by the encrypting light transmitted to an intended viewer's eye(s); the polarized lenses are configured to specifically decode the encrypting light by filtering out the encrypting light consisting of a wavelength of light between 620 nanometers and 750 nanometers;
encrypting light consisting of a wavelength of light between 620 nanometers and 750 nanometers transmitted by the display screen for the purpose of obscuring, eclipsing, manipulating, or preventing an unintended observer from discerning the intended visual imagery, data, entertainment, or other informative indicia upon the display screen, the predetermined wavelength of light to correspond with the pair of polarized glasses specifically adapted to filter the predetermined wavelength of light.
